(19) United States
(12) Patent Application Publication
(10) Pub. No.: US 2018/0372195 A1
(43) Pub. Date: Dec. 27, 2018

(54) LINEAR EXTENSION AND RETRACTION MECHANISM AND ROBOT ARM MECHANISM

(71) Applicant: LIFE ROBOTICS INC., Tokyo (JP)

(72) Inventor: Woo-Keun YOON, Tokyo (JP)

(21) Appl. No.: 16/115,832

(22) Filed: Aug. 29, 2018

Related U.S. Application Data
(63) Continuation of application No. PCT/JP2017/006722, filed on Feb. 23, 2017.

(30) Foreign Application Priority Data
Feb. 29, 2016 (JP) 2016-038465

(51) Int. Cl. F16H 19/06; B25J 18/02; F16G 13/20; F16H 19/04

(52) U.S. Cl. CPC F16H 19/0636; B25J 18/02; F16H 19/0663; F16H 19/0645; F16H 19/04; F16G 13/20

(57) ABSTRACT

A linear extension and retraction mechanism includes: a plurality of first pieces connected bendably with each other; a plurality of second pieces connected bendably with each other; and a plurality of rollers configured to cause the first pieces to join the second pieces so as to form an arm section in the form of a columnar body, and configured to support the arm section in a longitudinally movable manner. A drive gear is arranged behind the plurality of rollers, and the drive gear is configured to send out the first and second pieces forward from the plurality of rollers, and to pull back the first and second pieces to the plurality of rollers. The drive gear is engaged with linear gears on back surfaces of the plurality of first pieces. The drive gear is coupled to a motor unit by way of a power transmitting mechanism. The power transmitting mechanism includes a pair of bevel gears, and one of the pair of bevel gears is coupled to an output shaft of the motor unit, and the other of the pair of bevel gears is coupled to a rotary shaft 45 of the drive gear.

### CROSS-REFERENCE TO RELATED APPLICATIONS

This application is a continuation application of International Patent Application No. PCT/JP2017/006722 filed on Feb. 23, 2017, which is based upon and claims the benefit of priority from the Japanese Patent Application No. 2016-038465, filed Feb. 29, 2016 the entire contents of which are incorporated herein by reference.

### FIELD

An embodiment of the present invention relates to a linear extension and retraction mechanism and a robot arm mechanism.

### BACKGROUND

Recently, the possibility has been considered of situations where, besides nursing care robots, an industrial robot performs operations in the vicinity of a worker. If such a situation is realized, a handicapped person may be able to work in the same manner as a healthy person with the support of the robot, for example. The inventors have practically realized a robot arm mechanism of a polar coordinate type having a linear extension and retraction mechanism. The robot arm mechanism has no elbow joint and thus no singular points and hence, there is no possibility of the robot arm mechanism suddenly moving in an unexpected direction at high speed, and the movement of an arm and an end effector can be predicted. Accordingly, the robot arm mechanism has extremely high safety, thus making a safety fence unnecessary and realizing collaborative work between a robot and a worker. Currently, realization of collaborative work between the robot and the worker on a production line in a factory has been sought. The production line in the factory is designed so as to prevent space from being wasted as much as possible. To install a robot in the vicinity of a worker under such circumstances where space for installing the robot is limited, and to suppress an increase in size of the production line caused by installation of the robot, there is a demand for a reduction in size of a robot.

### SUMMARY OF INVENTION

### Technical Problem

A purpose of the present invention is to reduce the size of a robot arm mechanism.

### Solution to Problem

A linear extension and retraction mechanism according to this embodiment includes: a plurality of first pieces connected bendably with each other; a plurality of second pieces connected bendably with each other; and a plurality of rollers configured to cause the first pieces to join to the second pieces so as to form an arm section in the form of a columnar body, and configured to support the arm section in a longitudinally movable manner. A drive gear is arranged behind the plurality of rollers, and the drive gear is configured to send out the first and second pieces forward from the plurality of rollers, and to pull back the first and second pieces to the plurality of rollers. The drive gear is engaged with linear gears on back surfaces of the plurality of first pieces. The drive gear is attached to a motor unit by way of a power transmitting mechanism. The power transmitting mechanism includes a pair of bevel gears, and one of the pair of bevel gears is coupled to an output shaft of the motor unit, and the other of the pair of bevel gears is attached to a rotary shaft of the drive gear.

### BRIEF DESCRIPTION OF THE VIEWS OF THE DRAWING

FIG. 1 is a perspective view illustrating an external appearance of a robot arm mechanism which is provided with a linear extension and retraction mechanism according to this embodiment;

FIG. 2 is a side view illustrating an internal structure of the robot arm mechanism illustrated in FIG. 1;

FIGS. 3A and 3B are views illustrating a first piece 53 illustrated in FIG. 2;

FIGS. 4A and 4B are views illustrating a second piece 54 illustrated in FIG. 2;

FIG. 5 is a view illustrating a configuration of the robot arm mechanism illustrated in FIG. 1 using a symbolic description;

FIG. 6 is a side view illustrating a motor unit of a third joint J3 illustrated in FIG. 1 together with an up/down section;

FIG. 7 is a view illustrating members as viewed from an arrow A in FIG. 6; and

FIG. 8 is a plan view illustrating a structure of a power transmitting mechanism as viewed from above in cross section taken along line B-B in FIG. 6.

### DETAILED DESCRIPTION

Hereinafter, a linear extension and retraction mechanism according to the present embodiment is described with reference to drawings. The linear extension and retraction mechanism according to this embodiment may be used as a single mechanism (joint). In the description made hereinafter, a robot arm mechanism where one of a plurality of joints is formed of the linear extension and retraction mechanism according to this embodiment is described as an example. A robot arm mechanism of a polar coordinate type having the linear extension and retraction mechanism is described as the robot arm mechanism in this embodiment. However, the robot arm mechanism may be a robot arm mechanism of another type. In the description made hereinafter, the same reference characters are given to constitutional elements having substantially identical functions and configurations, and the repeated description thereof is made only when necessary.

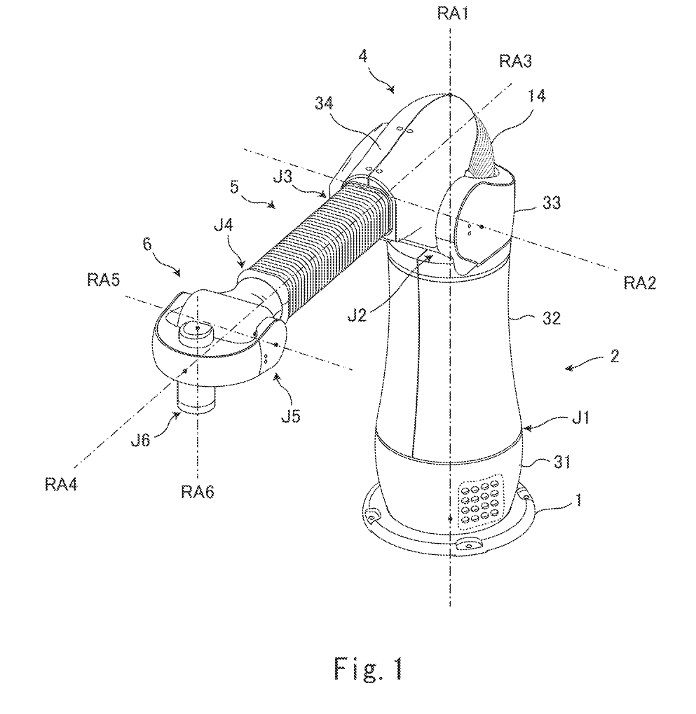

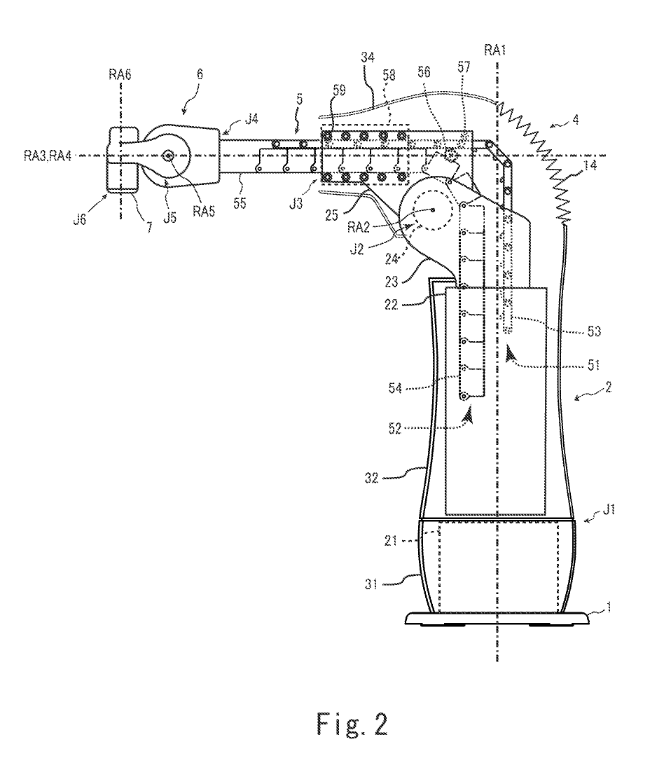

FIG. 1 illustrates an external appearance of a robot arm mechanism of a polar coordinate type having a linear extension and retraction mechanism according to this embodiment. FIG. 2 is a side view illustrating an internal structure of the robot arm mechanism illustrated in FIG. 1. The robot arm mechanism includes a base 1, a turning section 2, an up/down section 4, an arm section 5, and a wrist section 6. The turning section 2, the up/down section 4, the arm section 5, and the wrist section 6 are arranged in order from the base 1. A plurality of joints J1, J2, J3, J4, J5, J6 are arranged in order from the base 1. Typically, the turning section 2 in the form of a cylindrical body is vertically installed on the base 1. The turning section 2 houses the first joint J1 forming a turning rotational joint. The first joint 41 has an axis of torsional rotation RA1. The axis of rotation RA1 is parallel to a vertical direction. The turning section 2 includes a lower frame 21 and an upper frame 22. The lower frame 21 is coupled to a fixing section of the first joint J1. The lower frame 21 is covered by a housing 31 having a cylindrical shape. The upper frame 22 is coupled to a rotating section of the first joint J1, and axially rotates about the axis of rotation RA1. The upper frame 22 is covered by a housing 32 having a cylindrical shape. The upper frame 22 rotates with respect to the lower frame 21 with the rotation of the first joint J1 thus causing the arm section 5 to turn horizontally. In an inner hollow portion of the turning section 2 in the form of a cylindrical body, first and second piece strings 51, 5251, 52 of the third joint J3 forming a linear extension and retraction mechanism described later are accommodated. The up/down section 4 is installed on an upper portion of the turning section 2. The up/down section 4 houses the second joint J2 forming a rotational joint. The second joint J2 is a bending rotational joint. An axis of rotation RA2 of the second joint J2 is perpendicular to the axis of rotation RA1.

The up/down section 4 includes side frames 23 and an up/down frame 25. The side frames 23 are coupled to a fixing section of the second joint J2. The side frames 23 are covered by a housing having a saddle shape. The up/down frame 25 is coupled to a rotating section of the second joint J2. The up/down frame 25 is covered by a housing 34 having a cylindrical shape. With the rotation of the second joint. 42, the up/down frame 25 rotates with respect to the side frames 23 thus causing the arm section 5 to move upwardly or downwardly

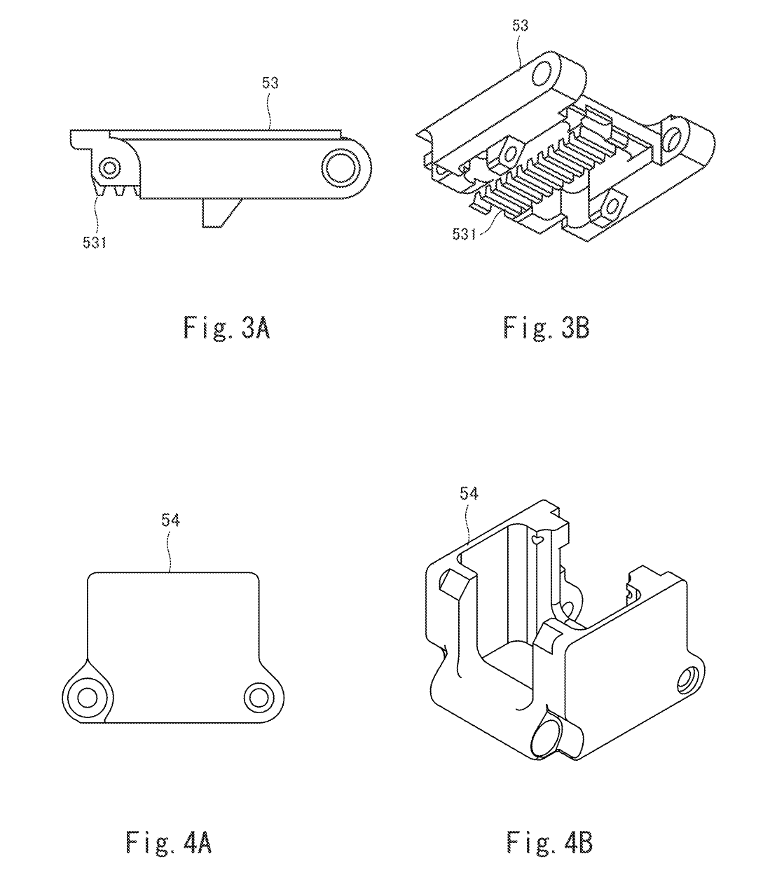

The third joint 43 is formed of the linear extension and retraction mechanism. The linear extension and retraction mechanism has a structure newly developed by the inventors thus being clearly distinct from a so-called linear motion joint. The third joint J3 has the arm section 5 as a movable section. The arm section 5 includes the first piece string 51 and the second piece string 52. The first piece string 51 is formed of a plurality of first pieces 53 which are connected bendably with each other. The second piece string 52 is formed of a plurality of second pieces 54. FIGS. 3A and 3B are views illustrating a structure of the first piece 53 illustrated in FIG. 2. FIGS. 4A and 4B are views illustrating a structure of the second piece 54 illustrated in FIG. 2. The first piece 53 has a substantially flat plate shape. A linear gear 531 is formed along a connecting direction on a back surface of the first piece 53 at the center in the width direction. When the plurality of first pieces 53 are linearly aligned, the linear gears 531 disposed adjacent to each other are connected with each other in a linear form thus forming a long linear gear. A drive gear 56 described later is meshed with this linear gear 531. The second piece 54 is formed of a groove-shaped body having a U-shape or a C-shape in transverse cross section. The second pieces 54 are bendably connected with each other using a connecting shaft disposed on bottom plates. Bending of the second piece string 52 is limited in a position where end surfaces of side plates of the second pieces 54 come into contact, with each other. When the second piece string 52 is in such a position, the second piece string 52 is linearly aligned. A leading first piece 53 of the first piece string 51 and a leading second piece 54 of the second piece string 52 are coupled to each other by a head piece 55. For example, the head piece 55 has a shape formed by combining the second piece 54 and the first piece 53 with each other.

The third joint J3 has a roller unit 58 as a fixing section. The roller unit. 58 is disposed at a front portion of the up/down section 4. The roller unit. 58 causes the first and second piece strings 51, 52 to join with each other thus forming the arm section 5 having a columnar shape and, at the same time, the roller unit. 58 supports the arm section 5 from an upward direction, a downward direction, a leftward direction, and a rightward direction. To be more specific, the roller unit 58 has a plurality of rollers 59 for firmly and movably supporting the arm section 5 from four directions of the upward direction, the downward direction, the leftward direction, and the rightward direction. The first and second piece strings 51, 52 are pressed toward each other when passing through the roller unit 58 so as to be joined together thus forming the arm section 5 having a columnar shape. The arm section 5 is firmly held by the roller unit 58 so that a joined state of the arm section 5 is maintained. When the joined state of the arm section 5 is maintained, the arm section 5 has linear rigidity. The drive gear 56 is arranged behind the roller unit 58. A guide roller 57 is arranged above the drive gear 56 at a distance equivalent to a thickness of the first piece 53 from the drive gear 56. The first piece 53 is sandwiched between the drive gear 56 and the guide roller 57. In such a state, the drive gear 56 is meshed with the linear gear 531 formed on the back surface of the first piece 53. The linear gears which are linearly connected with each other form a rack and pinion mechanism together with the drive gear 56. Although described later in detail, the drive gear 56 is coupled to a motor unit by way of a power transmitting mechanism. When the drive gear 56 rotates forward, the arm section 5 is sent out forward from the roller unit 35 together with the first piece string 51 along an axis of extension and retraction RA3. When the drive gear 56 rotates backward, the arm section 5 is pulled back to an area behind the roller unit 58 together with the first piece string 51. The first and second piece strings 51, 52 which are pulled back are separated from each other in the area behind the roller unit 58. The first and second piece strings 51, 52, which are separated from each other, are respectively restored to a bendable state. Both of the first and second piece strings 51, 52 which are restored to the bendable state are bent in the same direction (inward direction), and are accommodated in the turning section 2 in a vertical attitude. At this point of operation, the first piece string 51 is accommodated in a state of being substantially aligned with the second piece string 52 in a substantially parallel manner.

The wrist section 6 is attached to a tip of the arm section 5. The wrist section 6 is provided with the fourth to sixth joints J4 to J6. The fourth to sixth joints J4 to J6 respectively have axes of rotation RA4 to RA6 forming orthogonal three axes. The fourth joint J4 is a torsional rotational joint which rotates about the fourth axis of rotation RA4 which substantially agrees with the center axis of extension and retraction RA3, and the rotation of the fourth joint J4 causes an end effector to perform swing rotation. The fifth joint J5 is a bending rotational joint which rotates about the fifth axis of rotation RA5 disposed perpendicular to the fourth axis of rotation RA4, and the rotation of the fifth joint J5 causes the end effector to perform tilt rotation in a longitudinal direction. The sixth joint J6 is a torsional rotational joint which rotates about the sixth axis of rotation RA6 disposed perpendicular to the fourth axis of rotation RA4 and the fifth axis of rotation RA5, and the rotation of the sixth joint J6 causes the end effector to axially rotate.

The end effector is attached to an adaptor 7 disposed on a lower portion of a rotating section of the sixth joint J6 of the wrist section 6. The end effector is a part of a robot which has a function of directly acting on a work object (workpiece), and may be a variety of tool, such as a gripping section, a vacuum suction section, a nut fastening tool, a welding gun, or a spray gun, according to a task, for example. A variety of line, such as a power cable, a control cord, an air tube, or a water cooled cable, is coupled to the end effector corresponding to a type of such a tool. The end effector is moved to a desired position by the first, second, and third joints J1, J2, J3, and is arranged in a desired attitude by the fourth, fifth, and sixth joints J4, J5, J6. Particularly, a length of the extension and retraction distance of the arm section 5 of the third joint J3 allows the end effector to reach an object across a wide range from a position close to the base 1 to a position distantly separated from the base 1. A characteristic point which makes the third joint J3 different from a conventional linear motion joint lies in linear extension and retraction movement which is realized by the linear the extension and retraction distance of the third joint J3.

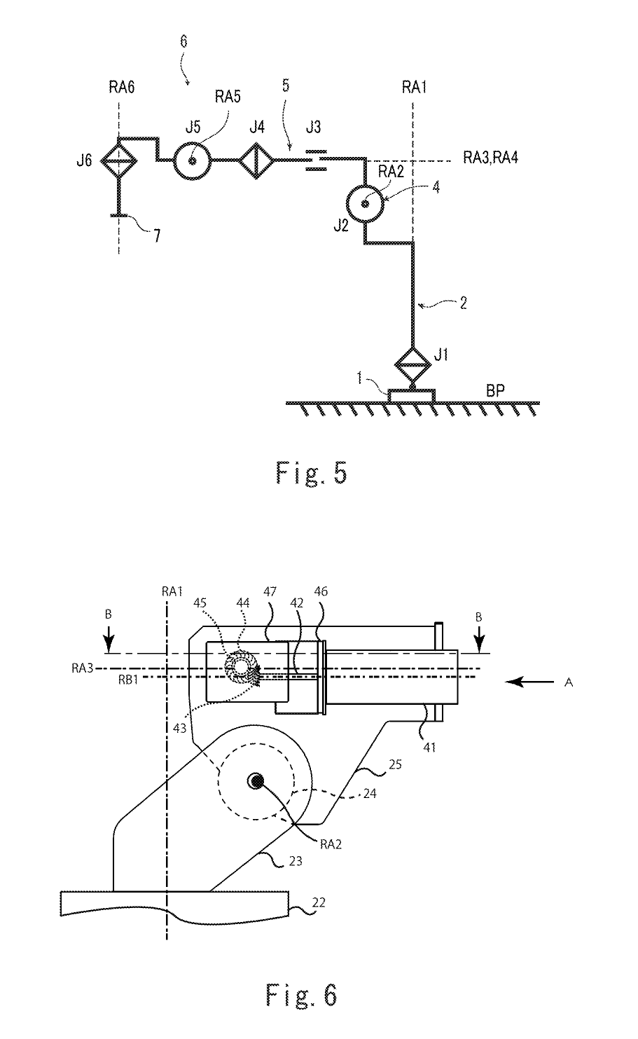

FIG. 5 is a view illustrating the robot arm mechanism illustrated in FIG. 1 using a symbolic description. In the robot arm mechanism, the first joint J1, the second joint J2, and the third joint J3 which form root three axes realize three degrees of freedom in position. Further, the fourth joint J4, the fifth joint J5, and the sixth joint J6 which form wrist three axes realize three degrees of freedom in attitude. As illustrated in FIG. 5, the axis of rotation RA1 of the first joint J1 is set to extend in a vertical direction. The axis of rotation RA2 of the second joint. J2 is set to extend in a horizontal direction. The second joint J2 is offset from the first joint J1 in two directions of the axis of rotation RA1 and an axis orthogonal to the axis of rotation RA1. The axis of rotation RA2 of the second joint J2 does not intersect with the axis of rotation RA1 of the first joint J1. The axis of movement RA3 of the third joint J3 is set to extend in the direction perpendicular to the axis of rotation RA2. The third joint J2 is offset from the second joint. J2 in two directions of the axis of rotation RA1 and the axis orthogonal to the axis of rotation RA1. The axis of rotation RA3 of the third joint J3 does not intersect with the axis of rotation RA2 of the second joint J2. One bending joint of the root three axes of the plurality of joints J1 to J6 is exchanged to a linear extension and retraction joint, the second joint J2 is offset from the first joint J1 in two directions, and the third joint J3 is offset, from the second joint J2 in two directions. With such a configuration, the robot arm mechanism of a robot device according to this embodiment eliminates a singular point attitude due to structure.

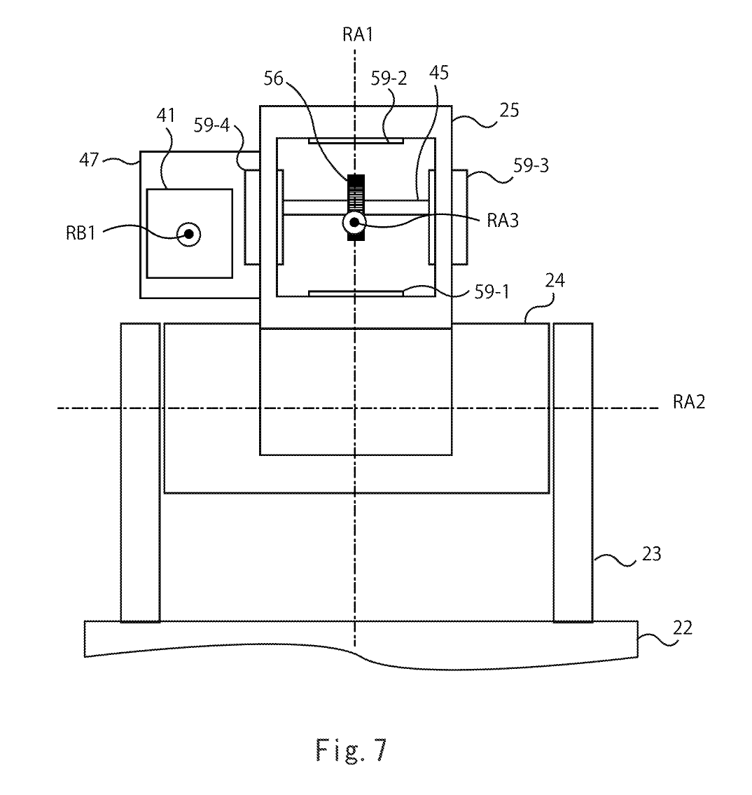

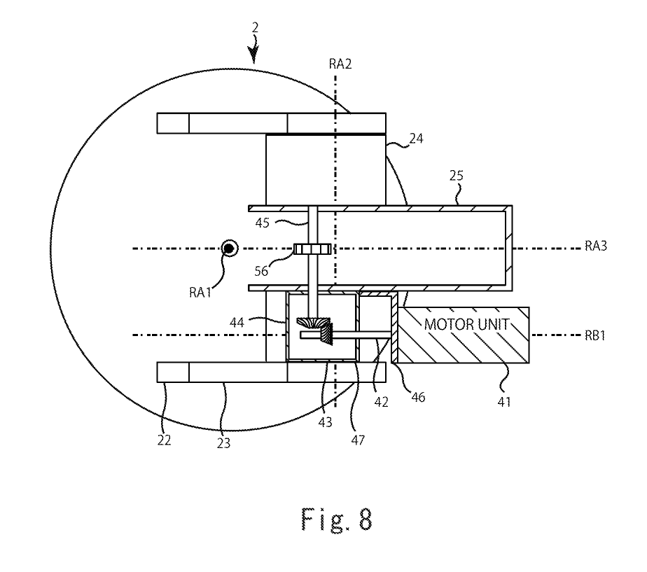

FIG. 6 is a side view illustrating a motor unit 41 of the robot arm mechanism illustrated in FIG. 1 together with the roller unit 58. FIG. 7 is a view illustrating members as viewed from an arrow A in FIG. 6. FIG. 8 is a plan view illustrating a structure of a transmission mechanism as viewed from above in cross section taken along line B-B in FIG. 6. The pair of side frames 23 are mounted on the upper frame 2 of the turning section 2. Both ends of a drum body 24 having a cylindrical shape are pivotally supported by the pair of side frames 23. A motor which generates power for driving the second joint J2 is accommodated in the drum body 24 together with a gear box. An output shaft of the gear box is fixed to one side frame 23. With the rotation of this output shaft, the drum body 24 pivots with respect to the pair of side frames 23. The up/down frame 25 is fixed to a peripheral surface of the drum body 24.

The up/down frame 25 is formed of a pair of plate-like frames disposed parallel to each other (referred to as “frame plates”) which are fixed to an outer circumferential surface of the drum body 24. The pair of frame plates disposed parallel to each other support the roller unit 58, the drive gear 56, and the guide roller 57 from both sides. The roller unit 58 is formed of: a plurality of upper rollers 59-1 which support the arm section 5 from the front surface side of the first pieces 53; a plurality of lower rollers 59-2 which support the arm section 5 from the bottom surface side of the second pieces 54; a plurality of left rollers 59-3 which support the arm section 5 from the left side; and a plurality of right rollers 59-4 which support the arm section 5 from the right side. The upper rollers 59-1 are arranged at a distance from the lower rollers 59-2, and the distance is equivalent to or slightly shorter than a total thickness of the first and second pieces 53, 54 which are joined together. The left rollers 59-3 are arranged at a distance from the right roller 59-4, and the distance is equivalent to or slightly shorter than the width of the first piece 53. With such a configuration, the plurality of rollers 59 can firmly and movably support the arm section 5 from four directions of the upward direction, the downward direction, the leftward direction, and the rightward direction. The drive gear 56 is arranged behind the plurality of rollers 59 together with the guide roller 57. The pair of frame plates rotatably support the drive gear 56 and the guide roller 57 from both sides. The direction of a rotary shaft 45 of the drive gear 56 is parallel to the axis of rotation RA2. The drive gear 56 is coupled to the motor unit 41 by way of the power transmitting mechanism.

The motor unit 41 is formed of the motor and the gear box, and generates power for driving the third joint J3. An input shaft of the gear box is connected to a rotary shaft of the motor. The output shaft of the gear box is coupled to the input shaft by way of a speed reduction gear set. The rotary shaft of the motor and the input shaft and the output shaft of the gear box are parallel to each other. The gear box is attached to a front portion of the motor. The motor unit 41 has a prismatiC-shape which extends in a direction parallel to the rotary shaft of the motor, and has a short length in a direction perpendicular to the rotary shaft of the motor. A center axis RB1 of the motor unit 41 means a center axis of the prism which is parallel to the longitudinal direction of the motor unit 41. The motor unit 41 includes an output shaft 42 parallel to the center axis RB1 of the motor unit 41. The motor unit 41 is attached to one of the pair of frame plates. To be more specific, the motor unit 41 is fixed to a front surface of the frame plate of the up/down frame 25 by an L-shaped fitting 46 such that the center axis RB1 of the motor unit 41 is parallel to the plate surface of the frame plate of the up/down frame 25 and, preferably, the center axis RB1 is parallel to the center axis of the arm section 5 supported by the roller unit 58. The output shaft 42 of the motor unit 41 arranged as described above is orthogonal to the rotary shaft 45 of the drive gear 56.

The power transmitting mechanism has a pair of bevel gears 43, 44 as a mechanism for converting rotation of the output shaft 42 of the motor unit 41 to rotation of the rotary shaft 45 orthogonal to the output shaft. 42. The pair of bevel gears 43, 44 are housed in a box-shaped casing 47. The pair of bevel gears generate high torque compared with a gear mechanism formed by combining spur gears or the like having two axes which are parallel to each other. Accordingly, employing the pair of bevel gears 43, 44 for the power transmitting mechanism reduces a risk of the arm section 5 easily moving when the motor unit 41 is prevented from generating a static torque due to a reason of failure or the like. The pair of bevel gears 43, 44 are preferably be a hypoid gear set formed of the hypoid pinion 43 and the hypoid gear 44. However, the pair of bevel gears 43, 44 may be formed of other bevel gears, for example, straight bevel gears, spiral bevel gears or the like. The spiral bevel gear is quiet., and suppresses generation of vibrations compared with the straight bevel gear. The hypoid gear set is quieter and can withstand higher load compared with the spiral bevel gear. One bevel gear 43 (drive bevel gear 43) out of the pair of bevel gears 43, 44 is attached to the output shaft 42 of the motor unit 41. The other bevel gear 44 (driven bevel gear 44) is attached to one end of the rotary shaft 45 of the drive gear 56, and is meshed with the drive bevel gear 43. The other end of the rotary shaft 45 of the drive gear 56 is pivotally supported by the frame plate of the up/down frame 25. With such a configuration, when the motor unit 41 is driven, the drive bevel gear 43 rotates with the rotation of the output shaft 42. The rotation of the drive bevel gear 43 causes the driven bevel gear 44 which is meshed with the drive bevel gear 43 to rotate thus rotating the drive gear 56 connected to the rotary shaft 45. Accordingly, power generated in the motor unit 41 by the pair of bevel gears 43, 44 is transmitted to the drive gear 56 including the rotary shaft 45 orthogonal to the output shaft 42 of the motor unit 41.

As has been described above, employing the pair of bevel gears 43, 44 for the power transmitting mechanism allows the output shaft 42 of the motor unit 41 to be arranged in the direction orthogonal to the rotary shaft 45 of the drive gear 56. This configuration allows a state to be realized where the motor unit 41 is fixed to the front surface of the frame plate of the up/down frame 25 with the center axis RB1 of the motor unit 41 extending parallel to the plate surface of the frame plate of the up/down frame 25. That is, the degree of freedom in arrangement layout of the motor unit 41 is enhanced.

Assume a case where a gear set which includes a rotary shaft parallel to the rotary shaft 45 of the drive gear 56 is employed for the power transmitting mechanism. In such a case, even if the motor unit 41 is arranged at any position on the inside of the up/down frame 25, on the front surface of the frame plate of the up/down frame 25, or on a front surface of a top plate of the up/down frame 25, an increase in size of a robot arm mechanism cannot be avoided. For example, when the motor unit 41 is arranged on the top plate of the up/down frame 25, the height of the robot arm mechanism is increased. When the motor unit 41 is arranged on the frame plate of the up/down frame 25, the center axis RB1 of the motor unit 41 is parallel to the axis of rotation RA2, thus increasing the width of the robot arm mechanism. When the motor unit 41 is arranged in the inside of the up/down frame 25, for example, between the first and second piece strings 51, 52, it is necessary to arrange the drive gear 56 at a predetermined distance, for example, at a distance equal to or more than the width of the motor unit 41, from the roller unit 58, thus increasing the length of the robot, arm mechanism.

In this embodiment., the pair of bevel gears 43, 44 are employed for the power transmitting mechanism, and the motor unit. 41 is fixed to the front surface of the frame plate of the up/down frame 25 such that the center axis RB1 of the motor unit 41 is parallel to the plate surface of the frame plate of the up/down frame 25. Such a configuration contributes to a reduction in size of the robot arm mechanism. This is because the up/down frame 25 is relatively large to support the drive gear 56, the guide roller 57, and the rollers 59 and hence, when the motor unit 41 is arranged along the frame plate of the large up/down frame 25, the motor unit 41 does not largely project in respective axial directions of the orthogonal three axes from the front surface of the frame plate of the up/down frame 25. Further, the drive gear 56 and the rollers 59 are arranged on the up/down frame 25 along the axis of extension and retraction RA3 and hence, the frame plate has a large length in the direction along the axis of extension and retraction RA3. Accordingly, fixing the motor unit 41 on the front surface of the frame plate of the up/down frame 25 such that the center axis RB1 of the motor unit 41 is parallel to the center axis of the arm section 5 which is supported by the roller unit 58, that is, parallel to the axis of extension and retraction RA3, is advantageous in further reducing the size of the robot arm mechanism.

Causing the motor unit. 41 and the drive gear 56 to be supported by the single up/down frame 25 allows a state to be realized where the motor unit 41 is arranged close to the drive gear 56. This configuration simplifies the power transmitting mechanism between the motor unit 41 and the drive gear 56 thus facilitating the assembling of the robot arm mechanism and, at the same time, reducing a risk of defect such as gear meshing failure between the motor unit 41 and the drive gear 56. A hypoid gear set which requires positioning accuracy can be employed for the power transmitting mechanism.

Further, fixing the motor unit 41 on the front surface of the frame plate of the up/down frame 25 prevents the motor unit 41 from being arranged in the inside of the up/down frame 25, for example, between the first and second piece strings 51, 52, thus realizing the arrangement of the drive gear 56 in the vicinity of a rear portion of the roller unit 58. The length of the up/down frame 25 in the direction along the axis of extension and retraction RA3 is dependent on the distance from the roller unit 58 to the drive gear 56. Accordingly, arranging the drive gear 56 in the vicinity of the rear portion of the roller unit 58 shortens the length of the up/down frame 25, thus contributing to a reduction in size of the robot arm mechanism.

It is assumed that the motor unit 41 is formed of the motor and the gear box. However, the motor unit 41 may not be provided with the gear box. In such a case, a drive bevel gear is attached to the output shaft of the motor. Further, it is assumed that the power transmitting mechanism includes the pair of bevel gears 43, 44. However, provided that the rotation of the motor unit 41 can be orthogonally converted into the rotation of the drive gear 56, another configuration may be employed. For example, a worm gear set, a crown gear set or the like may be employed as the power transmitting mechanism.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### REFERENCE SIGNS LIST

22 . . . upper frame, 23 . . . side frame, 24 . . . drum body, 25 . . . up/down frame, 41 . . . motor unit, 42 . . . output shaft, 43 . . . drive bevel gear, 44 . . . driven bevel gear, 45 . . . rotary shaft, 56 drive gear

1. A linear extension and retraction mechanism comprising:
a plurality of first pieces connected bendably with each other and having a plate shape;
a plurality of second pieces connected bendably with each other on a bottom surface side, and having an U-shape in transverse cross section, the first pieces and the second pieces, upon joining of the first pieces to the second pieces on a front surface side on a side opposite to the bottom surface side, being formed into a columnar body where the first pieces and the second pieces are restrained from bending thus stiffening, the first pieces and the second pieces being restored to a bent state with separation of the first pieces and the second pieces from each other;
a plurality of rollers configured to cause the first pieces to join to the second pieces so as to form the columnar body, and configured to support the columnar body in a longitudinally movable manner;
a drive gear configured to send out the first pieces and the second pieces forward from the plurality of rollers, and configured to pull back the first pieces and the second pieces rearward, the drive gear being meshed with linear gears formed on back surfaces of the plurality of first pieces, and being arranged behind the plurality of rollers;
a motor unit configured to generate power for rotating the drive gear; and
a power transmitting mechanism configured to transmit the power generated by the motor unit to the drive gear, wherein
the power transmitting mechanism includes a pair of bevel gears, and one of the pair of bevel gears is coupled to an output shaft of the motor unit, and the other of the pair of bevel gears is coupled to a rotary shaft of the drive gear.

2. The linear extension and retraction mechanism according to claim 1, wherein one of the pair of bevel gears is formed of a hypoid pinion, and the other of the pair of bevel gears is formed of a hypoid gear.

3. A linear extension and retraction mechanism comprising:
a plurality of first pieces connected bendably with each other and having a plate shape;
a plurality of second pieces connected bendably with each other on a bottom surface side, and having an U-shape in transverse cross section, the first pieces and the second pieces, upon joining of the first pieces to the second pieces on a front surface side on a side opposite to the bottom surface side, being formed into a columnar body where the first pieces and the second pieces are restrained from bending thus stiffening, the first pieces and the second pieces being restored to a bent state with separation of the first pieces and the second pieces from each other;
a plurality of rollers configured to cause the first pieces to join to the second pieces so as to form the columnar body, and configured to support the columnar body in a longitudinally movable manner;
a drive gear configured to send out the first pieces and the second pieces forward from the plurality of rollers, and configured to pull back the first pieces and the second pieces rearward, the drive gear being meshed with linear gears formed on back surfaces of the plurality of first pieces, and being arranged behind the plurality of rollers;
a motor unit configured to generate power for rotating the drive gear; and
a power transmitting mechanism configured to transmit the power generated by the motor unit to the drive gear, wherein
the motor unit is arranged such that a center axis of the motor unit is parallel to a center axis of the columnar body.

4. A linear extension and retraction mechanism comprising:
a plurality of first, pieces connected bendably with each other and having a plate shape;
a plurality of second pieces connected bendably with each other on a bottom surface side, and having an U-shape in transverse cross section, the first pieces and the second pieces, upon joining of the first pieces to the second pieces on a front surface side on a side opposite to the bottom surface side, being formed into a columnar body where the first pieces and the second pieces are restrained from bending thus stiffening, the first pieces and the second pieces being restored to a bent state with separation of the first pieces and the second pieces from each other;
a plurality of rollers configured to cause the first pieces to join to the second pieces so as to form the columnar body, and configured to support the columnar body in a longitudinally movable manner;
a drive gear configured to send out the first pieces and the second pieces forward from the plurality of rollers, and configured to pull back the first pieces and the second pieces rearward, the drive gear being meshed with linear gears formed on back surfaces of the plurality of first pieces, and being arranged behind the plurality of rollers;
a motor unit configured to generate power for rotating the drive gear; and
a power transmitting mechanism configured to transmit the power generated by the motor unit to the drive gear, wherein
the motor unit is arranged such that a center axis of the motor unit is parallel to plate surfaces of a pair of frame plates which support the plurality of rollers and the drive gear from both sides.
